(19) United States
(12) Patent Application Publication
(10) Pub. No.: US 2011/0205157 A1
(43) Pub. Date: Aug. 25, 2011

(54) System and Method for Information Handling System Touchpad Enablement

(76) Inventors: Erin K. Walline, Pflugerville, TX (US); Robert C. Nerhood, II, Round Rock, TX (US)

(21) Appl. No.: 12/711,509

(22) Filed: Feb. 24, 2010

(51) Int. Cl. G06F 3/033

(52) U.S. Cl. 345/158

(57) ABSTRACT

A disabled information handling system integrated pointing device is automatically enabled based upon user inputs detected at the integrated pointing device, such as inputs that indicate a user is unsuccessfully attempting to use the integrated pointing device. For example, a touchpad disposed at a portable information handling system housing in a disabled state automatically transitions to an enabled state when user inputs include rapid movements, movements from end to end or movements of increasing speed. The touchpad automatically transitions to an enabled state based upon movements interpreted as an attempt by the user to make inputs at the touchpad.

### BACKGROUND OF THE INVENTION

1. Field of the Invention

The present invention relates in general to the field of information handling system Input/Output (I/O) devices, and more particularly to a system and method for information handling system touchpad enablement.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One type of information handling system that has gained in popularity among end users is the portable information handling system. Portable systems are built in a relatively small and light weight housing that allows end users to carry the systems while operating the systems. To support mobile operations, a portable information handling system typically integrates in the housing a power source, such as a rechargeable battery, and I/O devices, such as a display, a keyboard and a pointing device. Integrated pointing devices include touchpads, also referred to as a mousepads, pointing sticks and, to a certain extent, touchscreens integrated in a display. Integrated pointing devices generally perform the function of a mouse by allowing an end user to position a cursor on a display and to make selections with cursor. For example, a touchpad is typically a flat touch-sensitive area disposed on a keyboard that moves a cursor at a display based upon an end user's finger movement across the touchpad. A pointing stick is typically a moveable device that extends from a keyboard and deflects in response to end user inputs that direct a cursor across a display. A touchscreen accepts touches by an end user at a screen as inputs. Integrated pointing devices enable end users to have mouse functionality when operating a portable system in a mobile configuration. When end users operate a portable system at a fixed location, they typically interface an external pointing device, such as a USB or wireless mouse, because such external pointing devices tend to be easier to use than integrated pointing devices.

In some instances, end users desire to disable integrated pointing devices from accepting inputs, such as to avoid inadvertent inputs when an external pointing device is in use. For example, an end user can sometimes disable a touchpad by navigating through a user interface and selecting a “Disable Touchpad” option or a “Disable touchpad when mouse is present” option. Some portable information handling systems have a touchpad disable button physically located on the housing, such as a dedicated button or a key or key combination at the integrated keyboard. One difficulty that arises with disabling a touchpad is that re-enabling the touchpad is confusing, especially where the portable system lacks a pointing device to navigate through user interfaces. If a touchpad is inadvertently disabled, an end user is understandably confused about the operation of the information handling system. Typically, end users do not navigate through user interfaces with keyboard commands and therefore have difficulty navigating through user interfaces to re-enable a touchpad if no pointing devices are available. Even where dedicated touchpad buttons or key combinations are available, inadvertent disablement of a touchpad might perplex an end user who does not realize what the dedicated buttons or key combinations do.

### SUMMARY OF THE INVENTION

Therefore a need has arisen for a system and method which automatically enables an integrated pointing device in response to end user indications of a desire to use a disabled integrated pointing device.

In accordance with the present invention, a system and method are provided which substantially reduce the disadvantages and problems associated with previous methods and systems for enabling an information handling system integrated pointing device. Inputs at a pointing device in a disabled state are monitored to differentiate inadvertent inputs from intended inputs. Detection of intended inputs as identified by comparison with predetermined parameters, such as directionality, speed, acceleration and repetition parameters, results in automatic enablement of the pointing device, such as by forwarding the inputs to processing components for presentation at a display.

More specifically, an information handling system is built from plural processing components, such as a CPU, hard disk drive, RAM and chipset. Input/Output (I/O) devices interface an end user with the processing component, such as a keyboard that receives inputs at keys, a display that outputs information as visual images, and pointing devices, such as a touchpad, pointing stick and touchscreen that detect end user touches as inputs. A disable module selectively disables pointing devices in response to user inputs, such as through graphical user interfaces or touching of buttons, keys or key combinations, or alternatively selectively disables pointing devices in an automated manner, such as by disabling pointing devices integrated in an information handling system housing if an external pointing device interfaces with an information handling system, such as a USB mouse peripheral. For example, inputs made at a disabled pointing device are not presented at a display of an information handling system, such as by moving a cursor. An enablement module monitors inputs made a disabled pointing device to differentiate between inadvertent inputs and intentional inputs that are meant for use by the information handling system, such as to move the cursor. For example, an intention to move a cursor by inputs at a pointing device is determined by an analysis of the directionality, timing, acceleration and repetition of movements. Upon detection of movements at the pointing device that are indicative of an intentional input, the enablement module automatically enables the pointing device to accept the inputs and following inputs.

The present invention provides a number of important technical advantages. One example of an important technical advantage is that an information handling system integrated pointing device is automatically enabled in response to end user indications of a desire to use a disabled integrated pointing device. Inputs at a disabled pointing device are monitored to differentiate an end user attempt to use the pointing device from inadvertent inputs so that attempts to use the disabled pointing device result in automatic re-enabling of the pointing device. The end user has the benefit of a disabled integrated pointing device when desired with a rapid and automated re-enablement based upon instinctive inputs by the end user rather than a command entered through an interface or otherwise known to the end user. Automated re-enablement ensures that an end user will have ready access to an integrated pointing device at a portable information handling system even where the pointing device is intentionally or inadvertently disabled.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram blow-up view of an information handling system having an integrated pointing device that recovers from a disabled to an enabled state based upon inputs made at the integrated pointing device;

FIG. 2 depicts a end user inputs at a touchpad surface area; and

FIG. 3 depicts a flow diagram of a process for enabling a disabled pointing device based upon inputs made at the pointing device.

### DETAILED DESCRIPTION

Monitoring inputs at a pointing device of an information handling system to enable the pointing device when an end user attempts to use the pointing device is indicated by the inputs helps to improve the user's experience by reducing frustration caused by inadvertently disabled pointing devices. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

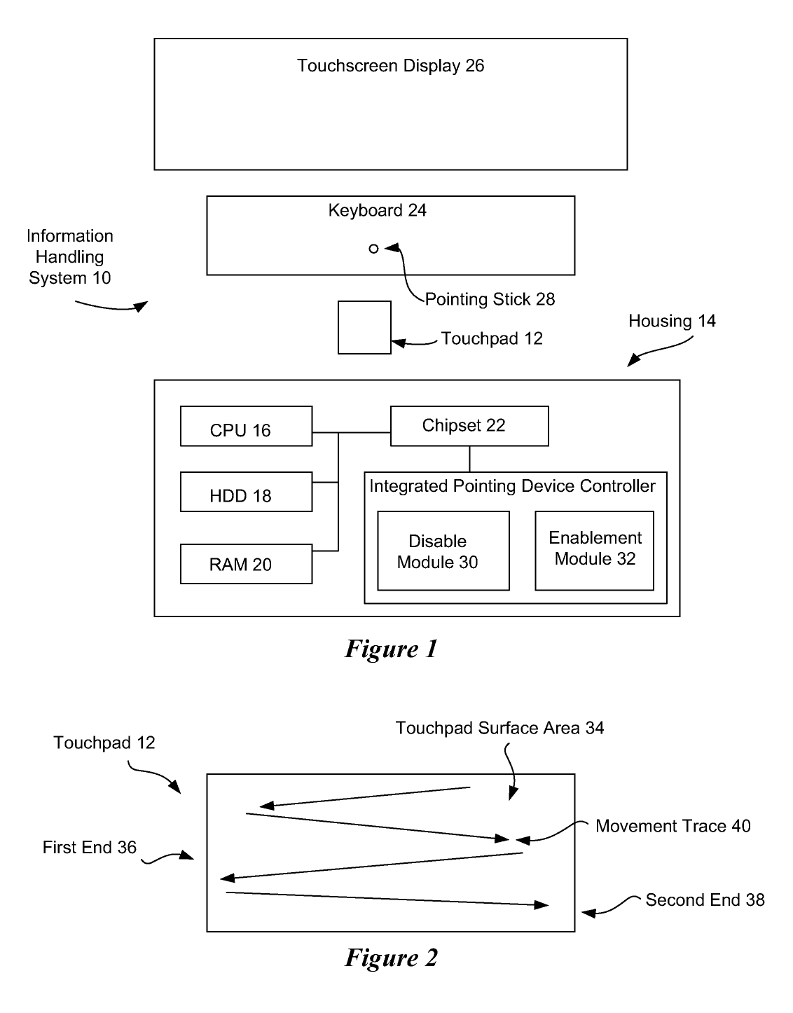

Referring now to FIG. 1, a block diagram depicts a blow-up view an information handling system 10 having an integrated pointing device, such as a touchpad 12, that recovers from a disabled to an enabled state based upon inputs made at the integrated pointing device. Information handling system 10 is built from plural processing components disposed in a housing 14. The processing components include a CPU 16, hard disk drive 18, RAM 20 and chipset 22 that cooperate to process information. For example, an application stored in non-volatile memory of hard disk drive 18 is executed on CPU 16 using RAM 20. Chipset 22 coordinates communication of information between the processing components and also with I/O devices, such as a keyboard 24 that accepts user inputs through keys, a display 26 that presents information as visual images, and a variety of integrated pointing devices that accept user inputs as movements made at each device. In the example embodiment depicted by FIG. 1, integrated pointing devices include a touchpad 12 that detects touches made by an end user and translates the touches to movement of a cursor, a pointing stick 28 that detects movements made by a user and translates the movements to movement of a cursor, and a touchscreen integrated with display 26 that accepts touches made by an end user as inputs depended upon information displayed at the display, such as moving a cursor or inputting at a displayed keyboard.

Integrated pointing devices generally work by detecting a touch and translating the touch into an electrical signal that is manipulated by a processor, such as a processor within chipset 22 or a microcontroller or other processor dedicated to the integrated pointing device, such as might be found on an application specific integrated circuit (ASIC). When in an enabled state, the integrated pointing device provides the processed electrical signals to the processing components for use in processing information, such as locating a cursor at a position on a display. When in a disabled state, the integrated pointing device generates electrical signals that are available for processing, however, the signals are not provided to other processing components for processing. A disable module 30 executes on a processor to place an integrated pointing device in a disabled state based upon an end user disable selection or an automated condition. For example, an end user might select a graphical user interface to disable inputs at an integrated pointing device from use by processing components or might select a button or key combination dedicated to disabling an integrated pointing device. As an alternate example, connecting an external pointing device, such as a mouse, to information handling system 10 is detected by disable module 30 to automatically initiate disabling of the integrated pointing device. Enablement module 32 executes on a processor to place an integrated pointing device in an enabled state, such as by transitioning from a manually or automatically selected disabled state to an enabled state in which inputs made at the integrated pointing device are used by the processing components. Disable module 30 and enable module 32 are, for example, firmware instructions that execute on a processor associated with integrated pointing device 12, or instructions executing as part of an operating system running on CPU 16.

Enablement module 32 monitors inputs made at integrated pointing device 12 when integrated pointing device 12 is in a disabled state and transitions integrated pointing device 12 to an enabled state if predetermined inputs are detected. Essentially, enablement module 32 distinguishes inadvertent inputs at integrated pointing device 12 from inputs that indicate an end user is attempting to use integrated pointing device 12 and enables integrated pointing device 12 if enablement module 32 determines an end user is attempting to make inputs. Generally, end user inputs that are indicative of an attempt to make inputs are inputs designed to move the cursor in a manner visually identifiable by the end user. One example of such movements is a rapid back and forth movement from side to side of the cursor. For example, enablement module 32 detects movement in opposing directions within a short time span, such as within a second of each other. Alternatively, enablement module detects movement within a predetermined distance of opposing sides of the integrated pointing device, such as at the outer circumference or within 1 mm of the outer circumference. Another example of such movement is a first movement followed by a second movement at a more rapid speed. Other factors that might identify such movements include a repetitive movement, a change of direction of a movement, a speed of a movement and the timing of plural movements relative to each other. Combinations of such factors can help to reduce the chance of mistaking inadvertent inputs with intentional inputs. Inadvertent versus intentional pointing device movements are distinguished by instructions running on a processor associated with the pointing device by analyzing the physical inputs made by a user at the pointing device while the pointing device is disabled. Once intentional inputs are determined, the pointing device is automatically enabled by enablement module 32 and the movements are presented at display 26. In one embodiment, a presentation at display 26 indicates to an end user that the integrated pointing device is disabled and indicates when automatic enablement of a disable integrated pointing device occurs.

Referring now to FIG. 2, end user inputs at a touchpad surface area 34 are depicted. Touchpad 12 has a defined surface area 34 in which an end user makes inputs by touching the surface. A movement trace 40 depicted between a first end 36 and second end 38 of touchpad surface area 34 presents an example of an intentional input made by a user to “wake-up” a disabled integrated pointing device. In the depicted example, rapid changes of direction across a touchpad surface, such as within a second time frame, indicates that the end user is intentionally attempting to make inputs at the touchpad. The rapid back and forth motion depicted by FIG. 2 represents a natural motion that and user might be expected to make to wake-up a non-responsive device, such as when an initial expected cursor motion does not occur in response to a touchpad input. By differentiating such intended inputs from inadvertent inputs, enablement module 32 selectively enables a disabled pointing device to accept the intended inputs and following inputs until the pointing device is again disabled, while continuing a disabled state in response to inadvertent inputs.

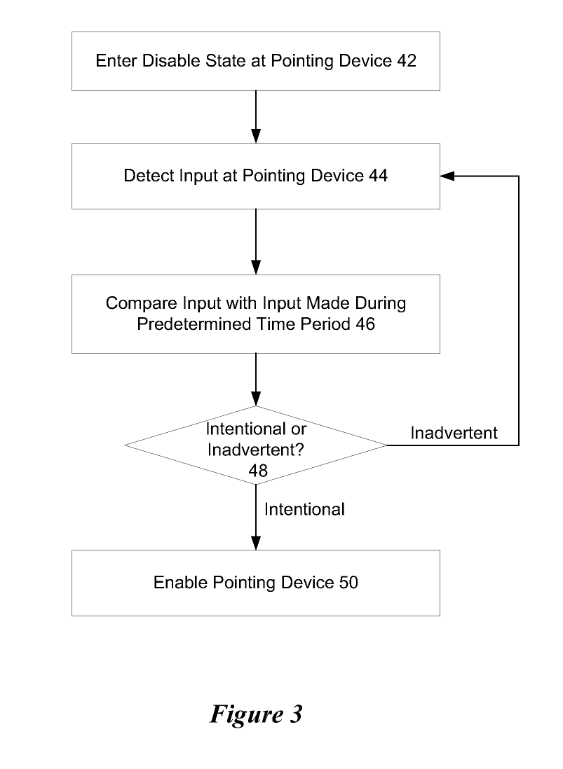

Referring now to FIG. 3, a flow diagram depicts a process for enabling a disabled pointing device based upon inputs made at the pointing device. The process begins at step 42 with entry of the integrated pointing device into a disabled state. For example, in the disabled state movements made at the pointing device are not translated into movements made by a cursor displayed at an information handling system having the pointing device integrated into its housing. At step 44, inputs are detected at the disabled pointing device. At step 46, the detected movements are compared with inputs made at the pointing device during a previous time period. For example, movements made at the pointing device over a predetermined time period, such as over a previous second, are analyzed to detect predetermined patterns of intentional inputs, such as by analyzing the directionality, timing, acceleration and repetition of the movements as parameters that identify purposeful inputs. At step 48, a determination is made of whether inputs made at the pointing device are intentional or inadvertent. If an intentional determination is made, the process continues to step 50 to enable the pointing device to accept and disable the inputs and subsequent inputs. If an inadvertent determination is made, the process continues to step 44 to maintain the pointing device in a disabled state and to continue monitoring inputs at the pointing device to detect intentional inputs.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
plural components disposed in the housing, the components operable to process information;
a display interfaced with the components and operable to present the information as visual images;
an integrated pointing device interfaced with the components and operable to accept end user inputs to move a cursor displayed on the display, the integrated pointing device having an enabled state in which end user inputs move the cursor and a disabled state in which end user inputs do not move the cursor; and
an enablement module interfaced with the integrated pointing device and operable transition the integrated pointing device from a disabled state to an enabled state in response to predetermined user inputs made at the integrated pointing device when the integrated pointing device is in a disabled state.

2. The information handling system of claim 1 wherein the integrated pointing device comprises a touchpad disposed at the housing.

3. The information handling system of claim 2 wherein the predetermined user inputs comprise a predetermined number of repetitions of a movement at the touchpad.

4. The information handling system of claim 2 wherein the predetermined user inputs comprise a predetermined number of changes in direction of a movement at the touchpad.

5. The information handling system of claim 4 wherein the touchpad has a surface area with opposing ends and wherein the predetermined number of changes in direction of movement comprise movement from within a predetermined distance of each of the opposing ends within a predetermined time period.

6. The information handling system of claim 2 wherein the predetermined user inputs comprise a predetermined speed of movement.

7. The information handling system of claim 6 wherein the predetermined speed of movement comprises an initial first speed of movement and a following second speed of movement within a predetermined time period, the second speed of movement greater than the first speed of movement.

8. The information handling system of claim 1 wherein the integrated pointing device comprises a pointing stick.

9. The information handling system of claim 1 wherein the integrated pointing device comprises a touchscreen display.

10. A method for enablement of an information handling system pointing device, the method comprising:
disabling the pointing device so that movement at the pointing device does not move a cursor at a display of the information handling system;
detecting predetermined inputs made at the disenabled pointing device; and
automatically enabling the pointing device in response to the detecting predetermined inputs so that the pointing device moves the cursor at the display in response to movement at the pointing device.

11. The method of claim 10 wherein the pointing device comprises a touchpad integrated into an information handling system housing.

12. The method of claim 10 wherein the predetermined inputs comprise a predetermined number of repetitions of a movement at the pointing device.

13. The method of claim 10 wherein the predetermined inputs comprise a predetermined number of changes in direction of a movement at the pointing device.

14. The method of claim 13 wherein the pointing device has a surface area with opposing ends and wherein the predetermined number of changes in direction of movement comprise movement from within a predetermined distance of each of the opposing ends within a predetermined time period.

15. The method of claim 10 wherein the predetermined inputs comprise a predetermined speed of movement.

16. The method of claim 15 wherein the predetermined speed of movement comprises an initial first speed of movement and a following second speed of movement within a predetermined time period, the second speed of movement greater than the first speed of movement.

17. The method of claim 10 wherein the pointing device comprises a pointing stick.

18. The method of claim 10 wherein the pointing device comprises a touchscreen display.

19. A system for automatically enabling a disabled pointing device, the system comprising:
a surface operable to translate user touches at the surface into electrical signals;
a processor interfaced with the surface and operable apply the electrical signals to present information at a display;
a disable module interfaced with the processor and operable to selectively disable presenting of information at the display in response to user touches; and
an enablement module interfaced with processor and operable to detect predetermined user inputs made at the surface when the disable module has disabled presenting of information at the display in response to user touches, and the enablement module further operable to enable presenting information in response to the predetermined user inputs.

20. The system of claim 19 wherein the surface comprises a touchpad disposed in a housing of a portable information handling system.
